(19) United States
(12) Patent Application Publication
(10) Pub. No.: US 2006/0083387 A1
(43) Pub. Date: Apr. 20, 2006

(54) Specific sound playback apparatus and specific sound playback headphone

(75) Inventor: Naohiro Emoto, Hamamatsu-shi (JP)

Correspondence Address: ROSSI, KIMMS & McDOWELL LLP., P.O. BOX 826, ASHBURN, VA, 20146-0826, US

(73) Assignee: Yamaha Corporation, Hamamatsu-shi (JP)

(21) Appl. No.: 11/230,025

(22) Filed: Sep. 19, 2005

(30) Foreign Application Priority Data
Sep. 21, 2004 (JP) 2004-273166

(51) Int. Cl. H04R 3/02; H04R 1/10

(52) U.S. Cl. 381/73.1; 381/74

(57) ABSTRACT

A specific sound playback apparatus buffers sound collected by a microphone in a sound storage section and determines the presence or absence of a phrase or a sound pattern previously registered in a sound pattern registration section. Upon detection of the registered phrase or sound pattern, the specific sound playback apparatus reads the sound from just before recording of the phrase or the sound pattern from the sound storage section and produces the sound from a loudspeaker. Therefore, a user usually can live in a house (room) where outdoor noise is insulated and silence is kept and if the sound containing the registered phrase or sound pattern is produced outdoor, the specific sound playback apparatus detects it and produces the recorded sound, so that the user does not fail to hear the registered phrase, etc.

### BACKGROUND OF THE INVENTION

This invention relates to a specific sound playback apparatus and a specific sound playback headphone, when a specific sound is detected in sounds occurring outside a sound-insulated space, for producing sound containing the specific sound into the sound-insulated space.

In recent years, various means have been devised to shut off noise and obtain a silent environment. For example, a soundproof sash including double glazing and a soundproof building material (wall material) excellent in sound insulating properties are becoming pervasive as means for shutting off external noise in a house. A noise canceling headphone for reducing ambient noise and providing silence is developed. (For example, refer to non-patent document 1.) Further, an active noise eliminator for effectively eliminating noise in a stationary noise sound field where noise cannot be determined is proposed. (For example, refer to patent document 1.)

Non-patent document 1: Bose export Inc., home page, quiet comfort (registered trademark) 2, (online), (search on Aug. 31, 2005), Internet <URL:

http://www.bose.com/controller?event=VIEW_PRODUCT_PAGE_EVE NT&product=qc2_headphones_index&ck=0>

Patent document 1: JP-A-2003-167584

A soundproof sash and a soundproof building material are used for a house, whereby external noise can be shut off for introducing silence into rooms. However, the soundproof sash and the soundproof building material shut off all outdoor sounds and thus the person in the house may fail to hear necessary sound information or emergency information such as voice providing a notification of collection of waste articles and a siren of a fire engine, for example.

On the other hand, the noise canceling headphone described in non-patent document 1 is designed for mainly canceling low-frequency noise and does not cancel the band of voice of a human being, etc., for safety. Thus, not only the necessary voice (sound), but also unnecessary voice is always heard; this is a problem.

The active sound absorber described in patent document 1 can absorb stationary noise in all bands, but is not intended for absorbing other sounds and thus cannot absorb any unnecessary sounds.

### SUMMARY OF THE INVENTION

It is therefore an object of the invention to provide a specific sound playback apparatus and a specific sound playback headphone for enabling the user to hear only necessary sound produced outside a sound-insulated space in the sound-insulated space and otherwise keeping the space silent.

To the end, according to the invention, there are provided the following:

(1) A specific sound playback apparatus comprising:

a sound collector that collects external sound;

a sound detector that detects specific sound from the sound collected by the sound collector;

a sound storage that buffers the sound collected by the sound collector; and

a sound output unit that reads sound containing the specific sound from the sound storage and outputs the sound when the sound detector detects the specific sound.

In the configuration, upon detection of a specific sound, the specific sound playback apparatus reads the sound containing the specific sound from the sound storage and produces the sound from the sound producing means. Therefore, the user can use the specific sound playback apparatus to hear the specific sound from the beginning. Since the specific sound playback apparatus produces the sound collected by the sound collector and recorded in the sound storage from the sound producing means, if the specific sound playback apparatus is set so as to detect a plurality of sounds as the specific sounds, the user can easily determine which sound is detected by hearing the sound. Further, if the specific sound playback apparatus erroneously detects a specific sound, the user can hear the actual sound and can easily determine erroneous detection. In addition, the external sound outside the room is not produced from the sound producing means except when the specific sound is detected, so that the sound-insulated room can be kept silent and only when a specific sound is detected outside the room, the user can hear the sound in the room.

(2) The sound detector includes phrase registration unit for registering a specific phrase and sound recognition unit for conducting sound recognition on the sound collected by the sound collector and detecting the phrase registered in the phrase registration unit.

In the configuration, the specific sound playback apparatus conducts sound recognition and detects a specific sound, so that it is made possible to reliably detect the specific phrase registered in the phrase registration unit.

(3) The sound detector includes waveform pattern registration unit for registering a specific sound pattern and sound analyzer for conducting analysis of frequency spectrum and waveform pattern on the sound collected by the sound collector and detecting the sound pattern registered in the waveform pattern registration unit.

In the configuration, the specific sound playback apparatus conducts analysis of frequency spectrum and waveform pattern and detects a specific sound pattern, so that it is made possible to reliably detect the specific waveform pattern registered in the waveform pattern registration unit.

(4) The specific sound playback apparatus according to (1), wherein the sound collector that collects external sound from outside a sound-insulated room, and the sound output unit outputs the sound to the sound-insulated room.

(5) A specific sound playback headphone comprising:

an internal sound collector that collecting internal sound inside an ear cup;

a sound output unit that outputs sound having phase opposite to that of the sound collected by the internal sound collector in the ear cup;

an external sound collector that collects external sound outside the ear cup;

a sound detector that detects specific sound from the sound collected by the external sound collector;

a sound storage that buffers the sound collected by the external sound collector; and

a specific sound output unit that reads sound containing the specific sound from the sound storage and outputs the sound from the sound output unit when the sound detector detects the specific sound.

In the configuration, the specific sound playback headphone collects internal sound inside the ear cup by the internal sound collector and produces sound of the opposite phase to the sound collected by the internal sound collector from the sound producing means, so that the sound entering the inside of the ear cup from the outside of the ear cup can be canceled by the sound of the opposite phase, and the inside of the ear cup can be placed in a space with the external sound insulated. Upon detection of a specific sound, the specific sound playback headphone reads the sound containing the specific sound from the sound storage and produces the sound from the sound producing means. Therefore, when a specific sound that the user needs to hear is produced outside the specific sound playback headphone, the user can reliably hear the sound without failing to hear the sound.

(6) The specific sound playback headphone according to (5), wherein the sound detector comprises a phrase registration unit for registering a specific phrase and a sound recognition unit for conducting sound recognition on the sound collected by the sound collector and detecting the phrase registered in the phrase registration unit.

(7) The specific sound playback headphone according to (1), wherein the sound detector comprises waveform pattern registration unit for registering a specific sound pattern and a sound analyzer for conducting analysis of frequency spectrum and waveform pattern on the sound collected by the sound collector and detecting the sound pattern registered in the waveform pattern registration unit.

(8) A method of playing back specific sound, the method comprising:

inputting external sound;

detecting specific sound from the collected sound;

buffering the collected sound;

reading sound containing the specific sound from the buffered sound and outputting the read sound when the specific sound is detected.

The specific sound playback apparatus of the invention is installed in a house with a soundproof sash, a soundproof room, etc., and the sound and the phrase to be detected are previously registered, whereby only when the specific sound playback apparatus detects necessary sound occurring outside the sound-insulated space, the person in the sound-insulated space can hear sound containing the sound and otherwise the space can be kept silent.

The user wearing the specific sound playback headphone of the invention can immediately obtain a silent environment and only when previously registered sound is produced in the surroundings of the user, the user can also hear sound containing the sound through the headphone.

### BRIEF DESCRIPTION OF THE DRAWINGS

In the accompanying drawings:

FIG. 1 is a block diagram to show the schematic configuration of a specific sound playback apparatus according to a first embodiment of the invention; and

FIG. 2 is a block diagram to show the schematic configuration of a specific sound playback apparatus according to a second embodiment of the invention.

### DETAILED DESCRIPTION OF PREFERRED EMBODIMENTS

### First Embodiment

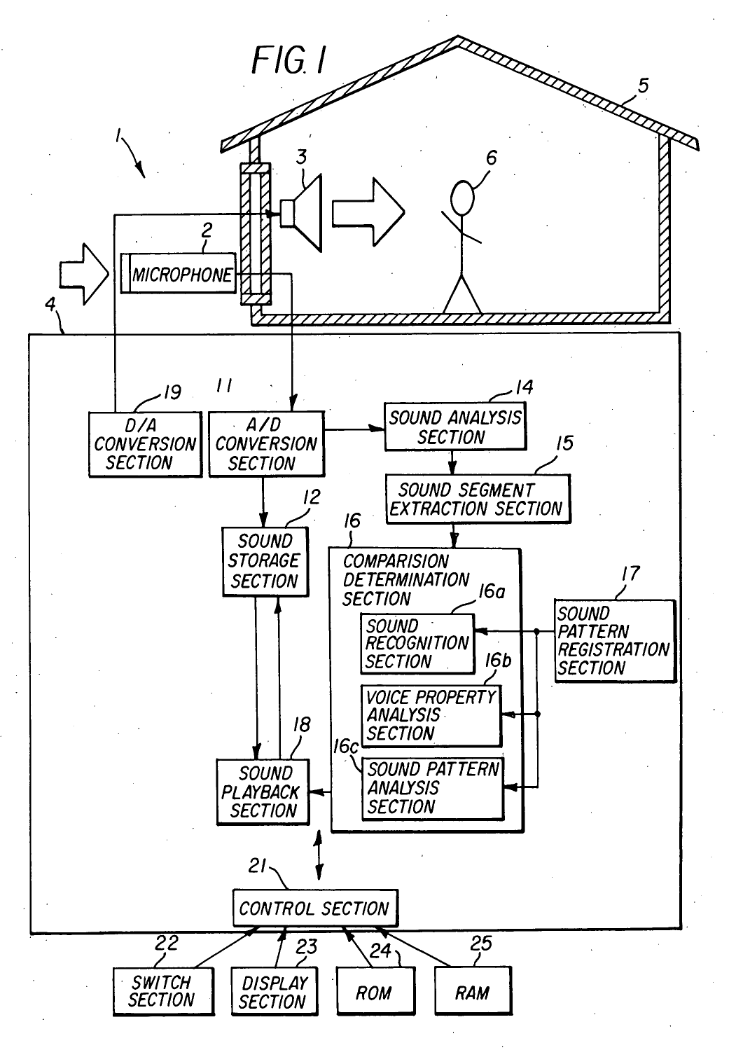

FIG. 1 is a block diagram to show the schematic configuration of a specific sound playback apparatus according to a first embodiment of the invention. A specific sound playback apparatus 1 is made up of a microphone 2 being installed at a corner of a window, etc., in a house 5 with outdoor noise insulated using a soundproof sash or a soundproof building material for collecting outdoor sound, a loudspeaker 3 for producing necessary sound for a user 6 in the house 5, and a circuit section 4 for detecting only necessary sound from the sound collected by the microphone 2. The circuit section 4 includes an A/D conversion section 11, a sound storage section 12, a sound analysis section 14, a sound segment extraction section 15, a comparison determination section 16, a sound pattern registration section 17, a sound playback section 18, a D/A conversion section 19, a control section 21, a switch section 22, a display section 23, ROM 24, and RAM 25.

The microphone 2 is connected to the A/D conversion section 11. The A/D conversion section 11 converts outdoor sound collected by the microphone 2 (analog sound) into digital form for output to the sound storage section 12 and the sound analysis section 14. The sound storage section 12 records (buffers) the digitized sound data continuously. The sound storage section 12 records record time information at regular time intervals (for example, in second units) together with the sound data so that the necessary portion of the sound data can be easily read.

The sound analysis section 14 outputs the sound data subjected to a cepstrum analysis, noise removal, and distortion correction to the sound segment extraction section 15 together with the record time information.

The sound segment extraction section 15 extracts sound segment data from the sound data output from the sound analysis section 14 and outputs the sound segment data to the comparison determination section 16 together with the record time information.

The comparison determination section 16 includes a sound recognition section 16a, a voice property analysis section 16b, and a sound pattern analysis section 16c, and determines whether or not the sound segment data output from the sound segment extraction section 15 contains a phrase, the voice of a speaker, sound pattern, etc., registered in the sound pattern registration section 17. That is, the sound recognition section 16a conducts sound recognition (phoneme recognition, word recognition, etc.,) on the sound of the phrase contained in the sound segment data and determines whether or not the sound segment data contains the phrase registered in the sound pattern registration section 17. The voice property analysis section 16b conducts analysis of frequency spectrum and waveform pattern on the voice of the speaker contained in the sound segment data and determines whether or not the sound segment data contains the voice of the speaker registered in the sound pattern registration section 17. The sound pattern analysis section 16c conducts analysis of frequency spectrum and wave form pattern on the sound pattern contained in the sound segment data and determines whether or not the sound segment data contains the sound pattern registered in the sound pattern registration section 17. If any of the sound recognition section 16a, the voice property analysis section 16b, or the sound pattern analysis section 16c detects at least any of the phrase, the voice of the speaker, or the sound pattern contained in the sound segment data and registered in the sound pattern registration section 17, the comparison determination section 16 outputs a signal to the effect that the phrase, the voice of the speaker, or the sound pattern has been detected to the sound playback section 18 together with the record time information of the detected phrase, voice, sound, etc.

The sound pattern registration section 17 is storage for previously registering sounds to be detected by the specific sound playback apparatus 1, such as a specific phrase, the voice of a specific speaker, and a specific sound pattern.

Upon reception of the record time information and the signal output from the comparison determination section 16, the sound playback section 18 reads the sound data recorded from just before the record time from the sound storage section 12 based on the record time information and outputs the read sound data to the D/A conversion section 19.

The D/A conversion section 19 converts the sound data (digital sound) output from the sound playback section 18 into analog form and outputs the analog data to the loudspeaker 3.

The loudspeaker 3 produces the sound output from the D/A conversion section 19. As the loudspeaker 3, an embedded loudspeaker embedded in an indoor wall or a ceiling for use, an AV loudspeaker used with an audio system, or the like can be used.

The control section 21 controls the operation of the sections of the specific sound playback apparatus 1. The control section 21 displays specific contents on the display section 23, reads a program from the ROM 24 for execution, and reads/writes data from/into the RAM 25 in response to a signal output from the switch section 22.

The switch section 22 includes a plurality of switches for the user to operate the specific sound playback apparatus 1 in various manners and outputs a signal responsive to the operation of each switch to the control section 21.

The display section 23 displays information provided by the specific sound playback apparatus 1 for the user in response to a signal output from the control section 21.

The ROM 24 stores the programs, etc., executed by the control section 21.

The RAM 25 temporarily stores a program, data, etc.

In the description given above, the microphone 2 and the loudspeaker 3 are connected to the circuit section 4 of the specific sound playback apparatus 1, but the invention is not limited to the mode. For example, the microphone 2 and the loudspeaker 3 are provided each with a radio communication section and the radio communication sections are connected to the A/D conversion section 11 and the D/A conversion section 19, whereby the circuit section 4 and the microphone 2 and the circuit section 4 and the loudspeaker 3 can be connected by radio waves.

Next, an outline of the operation of the specific sound playback apparatus 1 will be discussed. When the specific sound playback apparatus 1 starts to operate, it continuously records (buffers) sounds collected by the microphone 2 in the sound storage section 12 and determines whether or not a phrase or a sound pattern previously registered in the sound pattern registration section 17 is contained. If the specific sound playback apparatus 1 detects a registered phrase or sound pattern, it reads the sound data containing the phrase or the sound pattern from the sound storage section 12 and produces the sound data from the loudspeaker 3. Therefore, the user 6 usually can live in the house (room) where outdoor noise is insulated and silence is kept using a soundproof sash and soundproof building material and if the sound containing a specific phrase or a specific sound pattern registered in the sound pattern registration section 17 is produced outdoor, the specific sound playback apparatus 1 detects it and the user can hear the actual outdoor sound collected by the microphone 2 in the house (room) and thus can reliably listen to the registered specific phrase or specific sound pattern without failing to hear the phrase or sound pattern. If the specific sound playback apparatus 1 erroneously recognizes the phase or the sound pattern because the sound recognition rate or the sound pattern detection rate of the specific sound playback apparatus 1 is low, the user 6 can hear the actual sound and thus can easily determine erroneous recognition. Therefore, the specific sound detection rate of the specific sound playback apparatus 1 need not be 100% and if the detection rate is low to an extent, no problem arises.

Subsequently, the details of the operation of the specific sound playback apparatus 1 will be discussed. To operate the specific sound playback apparatus 1, the phrase and the sound pattern to be detected need to be previously registered in the sound pattern registration section 17. The user 6 can register a specific phrase and sound pattern in the sound pattern registration section 17 by using the microphone 2 or operating the switch section 22. A procedure for the user 6 to register a specific phrase and sound pattern by voice with the microphone 2 is as follows:

First, to register a specific phrase, the name of the user, etc., the user 6 performs operation for registering a phrase with the microphone 2. Upon detection of the operation performed through the switch section 22, the control section 21 records the sound (voice) input from the microphone 2 in the sound storage section 12 and starts to analyze the sound (voice). For example, if the user 6 utters “help,” the sound analysis section 14 makes noise removal and correction and the sound segment extraction section 15 extracts the sound data of the phrase of “help.” In the comparison determination section 16, the sound recognition section 16a conducts sound recognition and if it is detected that the phrase is the phrase of “help” registered in the sound pattern registration section 17, recognition information is output to the control section 21. The control section 21 displays on the display section 23 a message for the user to check whether or not the phrase of “help” is correct as the phrase to be detected. If the control section 21 detects that the user confirms the correct recognition through the switch section 22, the control section 21 registers the phrase of “help” in the sound pattern registration section 17 as the phrase to be detected.

To register a specific sound pattern, the user 6 performs operation for registering a sound pattern with the microphone 2. Upon detection of the operation performed through the switch section 22, the control section 21 records the sound input from the microphone 2 in the sound storage section 12 and starts to analyze the sound. For example, if the user 6 generates an audible alarm of a burglar alarm, the sound analysis section 14 makes noise removal and correction and the sound segment extraction section 15 extracts the sound data of the audible alarm. The comparison determination section 16 analyzes and extracts the frequency spectrum component, etc., and upon completion of the processing, outputs a signal indicating the processing result to the control section 21. The control section 21 causes the sound playback section 18 to play back the audible alarm of the burglar alarm read from the sound storage section 12 and displays on the display section 23 a message for the user to check whether or not the audible alarm is correct as the sound pattern to be detected. If the control section 21 detects that the user confirms the correct recognition through the switch section 22, the control section 21 registers the audible alarm of the burglar alarm in the sound pattern registration section 17 as the sound pattern to be detected.

To register the voice of a specific speaker, the user 6 performs operation for registering the voice of a specific speaker through the switch section 22 and inputs the recorded voice of the speaker to be registered from the microphone or the speaker directly reads out a typical sentence toward the microphone 2, whereby the voice of the speaker can be registered in the sound pattern registration section 17 as the user registers the specific sound pattern as described above.

Next, a procedure for the user 6 to register a specific phrase or a specific sound pattern in the sound pattern registration section 17 by operating the switch section 22 is as follows:

First, to register a specific phrase, the name of the user, etc., the user 6 performs operation for registering a phrase with the switch section 22. Upon detection of the operation performed through the switch section 22, the control section 21 waits until completion of input of the phrase. For example, if it is detected that the user 6 inputs a phrase of “fire,” the information of the input phrase is output to the control section 21. The control section 21 displays on the display section 23 a message for the user to check whether or not the phrase of “fire” is correct as the phrase to be detected. If the control section 21 detects that the user confirms the correct recognition through the switch section 22, the control section 21 registers the phrase (word) of “fire” in the sound pattern registration section 17 as the phrase to be detected.

A plurality of phrases are previously registered in the sound pattern registration section 17 as the phrases to be detected, so that the user 6 can also select the phrase to be detected. The user 6 performs operation for selecting the phrase to be detected by operating the switch section 22. Upon detection of the operation, the control section 21 displays the phrases to be detected on the display section 23. For example, phrases of “fire,” “help,” “wait,” etc., as emergency phrases for detecting a state of emergency, and phrases of “extra, extra”! (call for selling news paper)” “sweet potato! (call for selling sweet potato)” “ice cream ! (call for selling ice scream” etc., as living phrases for detecting a moving seller, etc., are displayed on the display section 23. The user 6 can operate the switch section 22 to select one or more phrases from among the phrases or select the emergency phrases and the living phrases by one operation. When a phrase is selected, the control section 21 displays a message for the user to check whether or not the selected phrase is correct on the display section 23. If the control section 21 detects that the user confirms the correct recognition through the switch section 22, the control section 21 registers the selected phrase in the sound pattern registration section 17 as the phrase to be detected.

A plurality of sound patterns are previously registered in the sound pattern registration section 17 as the sound patterns to be detected, so that the user 6 can also select the sound pattern to be detected. The user 6 performs operation for selecting the sound pattern to be detected by operating the switch section 22. Upon detection of the operation, the control section 21 displays the names of the sound patterns to be detected on the display section 23. For example, sound patterns names of “ambulance,” “fire engine,” “police car,” etc., as emergency sound patterns for detecting a state of emergency, and sound pattern names of “(school) chime,” “(factory) siren,” etc., as living sound patterns for detecting the time of day are displayed on the display section 23. The user 6 can operate the switch section 22 to select one or more sound patterns from among the sound patterns or select the emergency sound patterns and the living sound patterns by one operation. When a sound pattern is selected, the control section 21 displays a message for the user to check whether or not the selected sound pattern is correct on the display section 23 and also causes the sound playback section 18 to read out the sound patterns previously recorded in the sound storage section 12 and play back the sound patterns. If the control section 21 detects that the user confirms the correct recognition through the switch section 22, the control section 21 registers the selected sound pattern in the sound pattern registration section 17 as the sound pattern to be detected.

Upon completion of registration of the phrase, the voice of the speaker, the sound pattern to be detected as described above, it is made possible to operate the specific sound playback apparatus 1.

When the control section 21 of the specific sound playback apparatus 1 starts to operate, it records the sound colleted by the microphone 2 in the sound storage section 12 and also detects a specific sound such as the specific phrase, the specific speaker voice, or the specific sound pattern registered in the sound pattern registration section 17 by the sound analysis section 14, the sound segment extraction section 15, and the comparison determination section 16.

Here, assuming that the name of the user 6, the voice of the child of the user 6, and the sound patterns of an ambulance and a police car are previously registered in the sound pattern registration section 17 of the specific sound playback apparatus 1 by way of example, the operation is as follows:

When the specific sound playback apparatus 1 does not detect any phrase, any speaker voice, any sound pattern, etc., registered in the sound pattern registration section 17, no sound is output from the loudspeaker 3. Therefore, the house 5 uses the soundproof sash and the soundproof building material as described above, so that the indoor space with outdoor noise shut off can be kept silent.

When somebody calls the name of the user 6 outdoor during the operation of the specific sound playback apparatus 1, if the specific sound playback apparatus 1 detects that the sound collected by the microphone 2 contains the name of the user 6 according to the sound recognition conducted by the sound recognition section 16a of the comparison determination section 16, a signal indicating detection of the specific phrase and record time information are output to the sound playback section 18. Upon detection of the signal, the sound playback section 18 reads out the sound data containing the voice (sound) of somebody calling the name of the user 6 from just before recording of the voice (sound) (for example, 0.5 seconds before) based on the record time information from the sound storage section 12 and plays back the sound data, producing the sound (voice) from the loudspeaker 3. Accordingly, the user 6 in the house 5 can hear the sound (voice) produced outdoor and thus can know that the name of the user 6 was called and can also determine who called the name from the played-back sound (voice).

When the child of the user 6 comes near the house 5 while talking with a friend during the operation of the specific sound playback apparatus 1, if the specific sound playback apparatus 1 detects that the sound collected by the microphone 2 contains the voice of the child of the user 6 according to the analysis of frequency spectrum and waveform pattern conducted by the voice property analysis section 16b of the comparison determination section 16, a signal indicating detection of the specific speaker voice and record time information are output to the sound playback section 18. Upon detection of the signal, the sound playback section 18 reads out the sound data containing the sound of the voice of the child of the user 6 from just before recording of the voice of the child based on the record time information from the sound storage section 12 and plays back the sound data, producing the sound (voice) from the loudspeaker 3. Accordingly, the user 6 in the house 5 can hear the voice produced outdoor by the child of the user 6 and thus can determine that the child returns home. If the specific sound playback apparatus 1 erroneously recognizes a different person having a similar voice to that of the child of the user 6 as the voice of the child of the user 6 and produces the sound (voice) of the different person from the loudspeaker 3, the user 6 can hear the actual sound (voice) collected by the microphone 2 and can easily make estimation as to whether or not the sound (voice) is the voice of the child from the voice property, talking way, conversation, etc., of the child.

Further, when an ambulance or a police car stops in the vicinity of the house 5 during the operation of the specific sound playback apparatus 1, if the specific sound playback apparatus 1 detects that the sound collected by the microphone 2 contains sound of siren of the ambulance or the police car according to the analysis of frequency spectrum and sound pattern conducted by the sound pattern analysis section 16c of the comparison determination section 16, a signal indicating detection of the specific sound pattern and record time information are output to the sound playback section 18. Upon detection of the signal, the sound playback section 18 reads out the sound data containing the sound of the siren of the ambulance or the police car from just before recording of the sound of the siren based on the record time information from the sound storage section 12 and plays back the sound data, producing the sound from the loudspeaker 3. Accordingly, the user 6 in the house 5 can hear the specific sound pattern produced outdoor and thus can determine that an ambulance or a police car stops in the vicinity of the house 5.

In the specific sound playback apparatus 1, the sound playback section 18 reads out the sound data containing the specific sound from just before recording of the specific sound from the sound storage section 12 and produces the sound from the loudspeaker 3. However, the user can set the specific sound playback apparatus 1 so as to stop reading out the sound data upon completion of reading out sound data for a given time following the specific sound in addition to the sound data containing the specific sound. Accordingly, when the sound containing a specific phrase is detected, it is made possible for the user to hear the subsequent sound. The user can also set the specific sound playback apparatus 1 so as to continuously output sound until stopping reading out sound data by operating the switch section 22. Accordingly, the user can hear external sound for a while.

The specific sound playback apparatus 1 can also be set so that if it reads out the sound data from the sound storage section 12 continuously for a given time, the specific sound playback apparatus 1 stops reading out the sound data from the sound storage section 12 and produces the sound collected by the microphone 2 intact from the loudspeaker 3. Further, if the specific sound playback apparatus 1 is set as described above, some sounds are not played back. To prevent this, speech speed conversion can also be executed in the sound playback section 18 for switching the sound read from the sound storage section 12 into the sound collected by the microphone 2. Accordingly, the user can hear external sound in real time.

In the description given above, the circuit section 4 of the specific sound playback apparatus 1 is provided with sound recognition dictionary and the sound pattern registration section 17, but the invention is not limited to the configuration and any other configuration may be adopted. For example, the specific sound playback apparatus 1 may be connected to a network such as LAN and the sound recognition section 16a, the voice property analysis section 16b, and the sound pattern analysis section 16c placed in the comparison determination section 16 may be placed in an external server for accessing the external server through the network.

In the description given above, the configuration of connecting the microphone 2 and the loudspeaker 3 directly to the circuit section 4 is taken as an example, but the invention is not limited to the configuration and any other configuration may be adopted. For example, the microphone 2 and the circuit section 4 or the loudspeaker 3 and the circuit section 4 are connected through a network. The sound collected by the microphone 2 may be sent to the circuit section 4 via the network or the sound to be produced from the loudspeaker 3 may be sent to the loudspeaker 3 via the network. Accordingly, it is made possible to use the specific sound playback apparatus 1 as an apparatus for detecting a specific phrase and sound pattern from a remote location.

A plurality of (for example, two) microphones 2, loudspeakers 3, and sound storage sections 12 can also be provided for putting the specific sound playback apparatus 1 into multiple channels. In this case, presence can be furthermore enhanced by the sound produced from the plurality of loudspeakers. As the microphones and the loudspeakers are placed in association with each other so as to determine the direction from which sound is heard, which direction the sound is heard from can also be determined by the sound produced from each loudspeaker.

A plurality of the specific sound playback apparatus 1 according to the embodiment of the invention can also be installed with given spacing for monitoring sounds produced from the loudspeakers 3 of the specific sound playback apparatus 1, placed in one location as application to a security system. For example, a phrase or a sound pattern providing a notification of a state of emergency is previously registered in the sound pattern registration section 17 of each of the specific sound playback apparatus 1 installed as described above and the loudspeakers 3 of the specific sound playback apparatus 1 are installed in a centralized control room. In doing so, only the specific sound playback apparatus 1 detecting the phrase or the sound pattern providing a notification of a state of emergency produces the sound collected by the microphone 2 from the loudspeaker 3 only when a state of emergency occurs. Therefore, the manager stationed at the centralized control room can easily keep track of the point where the state of emergency occurs. Usually, each specific sound playback apparatus 1 does not produce the sound collected by the microphone 2 from the loudspeaker 3, so that the inside of the centralized control room can be kept silent.

### Second Embodiment

The specific sound playback apparatus described in the first embodiment can be applied to a sound insulation headphone. That is, the specific sound playback apparatus of the invention is applied to a sound insulation headphone for producing sound of the opposite phase to external sound in an ear cup, thereby canceling the external sound (noise), so that the user wearing the sound insulation headphone can immediately obtain silence and only when previously registered sound is produced in the surroundings of the user, the user can also hear the sound through the headphone.

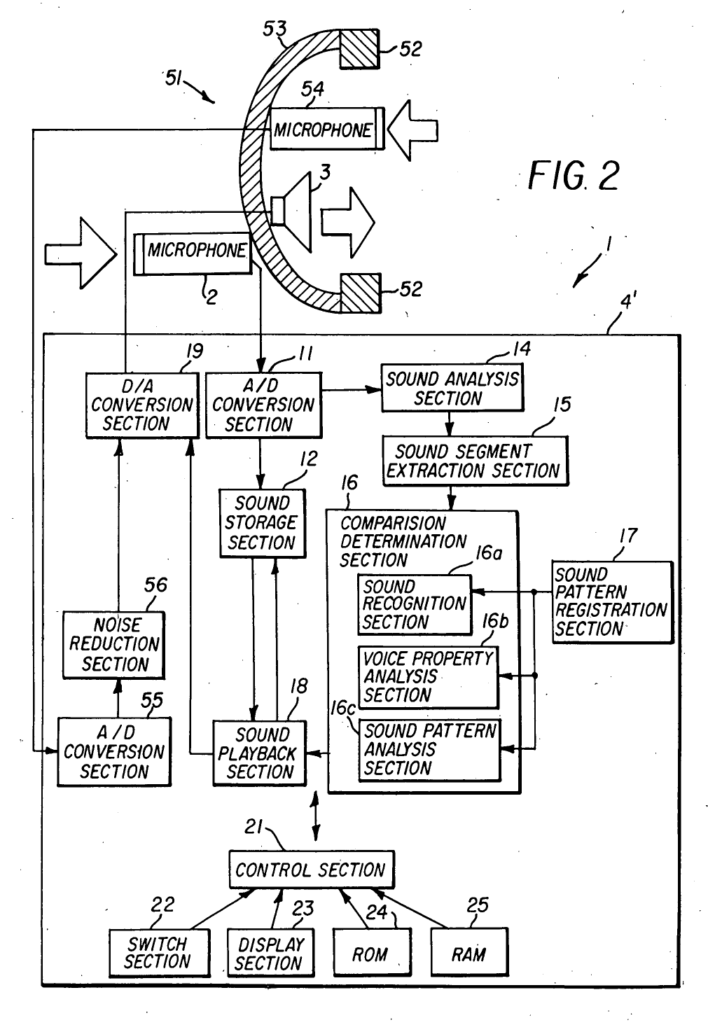

A specific sound playback headphone provided by applying the specific sound playback apparatus of the invention to a sound insulation headphone will be discussed in detail. FIG. 2 is a block diagram to show the schematic configuration of a specific sound playback apparatus according to a second embodiment of the invention. Components similar to those of the specific sound playback apparatus 1 previously described with reference to FIG. 1 are denoted by the same reference numerals in a specific sound playback headphone 51 shown in FIG. 2 and will not be discussed again in detail. Although the specific sound playback headphone 51 is of a structure wherein the user wears ear cups on both ears, only one ear cup is shown for simplicity of the description.

The specific sound playback headphone 51 has a cup-shaped ear cup 53 with a cushion 52 attached to the surroundings thereof, the ear cup provided with a microphone and a loudspeaker. That is, the ear cup 53 is provided on the outside with a microphone 2 for collecting external sound. The ear cup 53 is also provided on the inside with a loudspeaker 3 for producing sound in the inside of the ear cup 53 and a microphone 54 for collecting sound propagated from the outside to the inside of the ear cup 53. The microphone 2 is connected to an A/D conversion section 11 of a circuit section 4′, the loudspeaker 3 is connected to an D/A conversion section 19 of the circuit section 4′, and the microphone 54 is connected to an A/D conversion section 55 of the circuit section 4′.

The circuit section 4′ is provided by adding the A/D conversion section 55 and a noise reduction section 56 to the circuit section 4 of the specific sound playback apparatus 1, and is the same as the circuit section 4 except for the added components.

The A/D conversion section 55 is connected on the input side to the microphone 54 and on the output side to the noise reduction section 56. The noise reduction section 56 is placed between the A/D conversion section 55 and the D/A conversion section 19.

The A/D conversion section 55 converts sound collected by the microphone 54 into digital form and outputs the digital signal to the noise reduction section 56.

The noise reduction section 56 detects external sound (noise) entering the inside of the ear cup 53, collected by the microphone 54 inside the ear cup 53, generates a sound signal of the opposite phase to that of the detected sound, and outputs the sound data to the D/A conversion section 19.

The D/A conversion section 19 converts the sound data output from the noise reduction section 56 and sound data output from a sound playback section 18 into analog form and outputs the analog signal to the loudspeaker 3.

Accordingly, the sound of the opposite phase to that of the external sound (noise) entering the inside of the ear cup is produced from the loudspeaker 3 and thus the sound of the opposite phase and the external sound entering the inside cancel each other. As the phrase, speaker voice, sound pattern, and the like to be detected are previously registered in a sound pattern registration section 17 as with the specific sound playback apparatus 1, only when sound containing the specific phrase or sound pattern is produced outside the ear cup 53, the specific sound playback headphone 51 detects the sound and produces the sound from the loudspeaker 3.

Therefore, the user wearing the specific sound playback headphone 51 can hear external sound only when the previously registered specific sound is detected, and usually can obtain silence as with the use of the specific sound playback apparatus 1.

By way of example, to use the specific sound playback headphone 51 in a train, it is advisable for the user to operate a switch section 22 to previously register the name of the station where the user will get off the train in the sound pattern registration section 17. Accordingly, the specific sound playback headphone 51 detects an announcement just before the train arrives at the station where the user will get off, and produces the sound (voice) from the loudspeaker 3, so that the user can obtain a silent environment until just before the train arrives at the station where the user will get off, and can be prevented from passing through the station where the user will get off.

The sound insulation headphone in the related art is designed for mainly canceling low-frequency noise and does not cancel the band of voice of a human being, etc., for safety. However, the specific sound playback headphone 51 of the invention enables the user to reliably hear the necessary sound as described above and thus can be designed for canceling noise in all bands rather than only low-frequency noise.

Thus, the specific sound playback headphone 51 differs from the specific sound playback apparatus 1 in the structure, but can detect only specific sound and produce the specific sound for the user like the specific sound playback apparatus 1.

What is claimed is:

1. A specific sound playback apparatus comprising:
a sound collector that collects external sound;
a sound detector that detects specific sound from the sound collected by the sound collector;
a sound storage that buffers the sound collected by the sound collector; and
a sound output unit that reads sound containing the specific sound from the sound storage and outputs the sound when the sound detector detects the specific sound.

2. The specific sound playback apparatus according to claim 1, wherein the sound detector comprises a phrase registration unit for registering a specific phrase and a sound recognition unit for conducting sound recognition on the sound collected by the sound collector and detecting the phrase registered in the phrase registration unit.

3. The specific sound playback apparatus according to claim 1, wherein the sound detector comprises waveform pattern registration unit for registering a specific sound pattern and a sound analyzer for conducting analysis of frequency spectrum and waveform pattern on the sound collected by the sound collector and detecting the sound pattern registered in the waveform pattern registration unit.

4. The specific sound playback apparatus according to claim 1, wherein the sound collector that collects external sound from outside a sound-insulated room, and the sound output unit outputs the sound to the sound-insulated room.

5. A specific sound playback headphone comprising:
an internal sound collector that collecting internal sound inside an ear cup;
a sound output unit that outputs sound having phase opposite to that of the sound collected by the internal sound collector in the ear cup;
an external sound collector that collects external sound outside the ear cup;
a sound detector that detects specific sound from the sound collected by the external sound collector;
a sound storage that buffers the sound collected by the external sound collector; and
a specific sound output unit that reads sound containing the specific sound from the sound storage and outputs the sound from the sound output unit when the sound detector detects the specific sound.

6. The specific sound playback headphone according to claim 5, wherein the sound detector comprises a phrase registration unit for registering a specific phrase and a sound recognition unit for conducting sound recognition on the sound collected by the sound collector and detecting the phrase registered in the phrase registration unit.

7. The specific sound playback headphone according to claim 5, wherein the sound detector comprises waveform pattern registration unit for registering a specific sound pattern and a sound analyzer for conducting analysis of frequency spectrum and waveform pattern on the sound collected by the sound collector and detecting the sound pattern registered in the waveform pattern registration unit.

8. A method of playing back specific sound, the method comprising:
inputting external sound;
detecting specific sound from the collected sound;
buffering the collected sound;
reading sound containing the specific sound from the buffered sound and outputting the read sound when the specific sound is detected.
